(19) United States
(12) Patent Application Publication
(10) Pub. No.: US 2026/0162314 A1
(43) Pub. Date: Jun. 11, 2026

(54) VIDEO GENERATION

(71) Applicants: Lemon Inc., Grand Cayman (KY); Beijing Zitiao Network Technology Co., Ltd., Haidian District, Beijing (CN)

(72) Inventors: Junfei Xiao, Los Angeles, CA (US); Lu Jiang, Los Angeles, CA (US); Feng Cheng, Los Angeles, CA (US); Lu Qi, Beijing (CN); Liangke Gui, Los Angeles, CA (US); Jiepeng Cen, Beijing (CN); Zhibei Ma, Los Angeles, CA (US)

(21) Appl. No.: 18/874,479

(22) PCT Filed: Dec. 11, 2024
(86) PCT No.: PCT/CN2024/138635

§ 371 Date: Dec. 12, 2024

(51) Int. Cl. G06T 11/00; G06N 3/04; G06N 3/0895

(52) U.S. Cl. CPC G06T 11/00; G06N 3/04; G06N 3/0895

(57) ABSTRACT

Embodiments of the present disclosure provide a solution for video generation. A method comprises: generating a token sequence based on an input text using an auto-regressive model, the token sequence comprising a plurality of token groups, each token group comprising an action token and a caption token associated with a video clip, the action token indicating a theme of the video clip; determining text conditional information and visual conditional information based on the token sequence, the text conditional information comprising a plurality of caption tokens comprised in the token sequence; and generating a plurality of video clips based at least on the text conditional information and the visual conditional information.

### FIELD

The disclosed example embodiments relate generally to the field of computer science, particularly to a method, device, and storage medium for video generation.

### BACKGROUND

In recent years, video generation models have shown promising results in producing high-quality video clips lasting several seconds. However, these models face challenges in generating long sequences that convey clear and informative events, limiting their ability to support coherent narrations.

### SUMMARY

In a first aspect of the present disclosure, there is provided a method for video generation. The method comprises: generating a token sequence based on an input text using an auto-regressive model, the token sequence comprising a plurality of token groups, each token group comprising an action token and a caption token associated with a video clip, the action token indicating a theme of the video clip; determining text conditional information and visual conditional information based on the token sequence, the text conditional information comprising a plurality of caption tokens comprised in the token sequence; and generating a plurality of video clips based at least on the text conditional information and the visual conditional information.

In a second aspect of the present disclosure, there is provided an electronic device. The device comprises at least one processing unit; and at least one memory coupled to the at least one processing unit and storing instructions executable by the at least one processing unit, the instructions, upon execution by the at least one processing unit, causing the electronic device to perform actions comprising: generating a token sequence based on an input text using an auto-regressive model, the token sequence comprising a plurality of token groups, each token group comprising an action token and a caption token associated with a video clip, the action token indicating a theme of the video clip; determining text conditional information and visual conditional information based on the token sequence, the text conditional information comprising a plurality of caption tokens comprised in the token sequence; and generating a plurality of video clips based at least on the text conditional information and the visual conditional information.

In a third aspect of the present disclosure, a non-transitory computer-readable storage medium is provided. The non-transitory computer-readable storage medium has a computer program stored thereon which, upon execution by an electronic device, causes the device to perform actions comprising: generating a token sequence based on an input text using an auto-regressive model, the token sequence comprising a plurality of token groups, each token group comprising an action token and a caption token associated with a video clip, the action token indicating a theme of the video clip; determining text conditional information and visual conditional information based on the token sequence, the text conditional information comprising a plurality of caption tokens comprised in the token sequence; and generating a plurality of video clips based at least on the text conditional information and the visual conditional information.

It would be appreciated that the content described in the Summary section of the present invention is neither intended to identify key or essential features of the embodiments of the present disclosure, nor is it intended to limit the scope of the present disclosure. Other features of the present disclosure will be readily envisaged through the following description.

### BRIEF DESCRIPTION OF THE DRAWINGS

The above and other features, advantages and aspects of the embodiments of the present disclosure will become more apparent in combination with the accompanying drawings and with reference to the following detailed description. In the drawings, the same or similar reference symbols refer to the same or similar elements, where:

FIG. 1 illustrates a schematic diagram of an example environment in which embodiments of the present disclosure may be implemented;

FIG. 2 illustrates a flow chart of a process for video generation in accordance with some embodiments of the present disclosure,

FIG. 3A illustrates an example auto-regressive model in accordance with some embodiments of the present disclosure;

FIG. 3B illustrates an example video generation model in accordance with some embodiments of the present disclosure;

FIG. 4 illustrates a block diagram of an apparatus for video generation in accordance with some embodiments of the present disclosure; and

FIG. 5 illustrates a block diagram of an electronic device in which one or more embodiments of the present disclosure can be implemented.

### DETAILED DESCRIPTION

The embodiments of the present disclosure will be described in more detail below with reference to the accompanying drawings. Although some embodiments of the present disclosure are shown in the drawings, it would be appreciated that the present disclosure may be implemented in various forms and should not be interpreted as limited to the embodiments described herein. On the contrary, these embodiments are provided for a more thorough and complete understanding of the present disclosure. It would be appreciated that the drawings and embodiments of the present disclosure are only for the purpose of illustration and are not intended to limit the scope of protection of the present disclosure.

In the description of the embodiments of the present disclosure, the term “including” and similar terms would be appreciated as open inclusion, that is, “including but not limited to”. The term “based on” would be appreciated as “at least partially based on”. The term “one embodiment” or “the embodiment” would be appreciated as “at least one embodiment”. The term “some embodiments” would be appreciated as “at least some embodiments”. Other explicit and implicit definitions may also be included below. As used herein, the term “model” can represent the matching degree between various data. For example, the above matching degree can be obtained based on various technical solutions currently available and/or to be developed in the future.

It will be appreciated that the data involved in this technical proposal (including but not limited to the data itself, data acquisition or use) shall comply with the requirements of corresponding laws, regulations and relevant provisions.

It will be appreciated that before using the technical solution disclosed in each embodiment of the present disclosure, users should be informed of the type, the scope of use, the use scenario, etc. of the personal information involved in the present disclosure in an appropriate manner in accordance with relevant laws and regulations, and the user's authorization should be obtained.

For example, in response to receiving an active request from a user, a prompt message is sent to the user to explicitly prompt the user that the operation requested operation by the user will need to obtain and use the user's personal information. Thus, users may select whether to provide personal information to the software or the hardware such as an electronic device, an application, a server or a storage medium that perform the operation of the technical solution of the present disclosure according to the prompt information.

As an optional but non-restrictive implementation, in response to receiving the user's active request, the method of sending prompt information to the user may be, for example, a pop-up window in which prompt information may be presented in text. In addition, pop-up windows may also contain selection controls for users to choose “agree” or “disagree” to provide personal information to electronic devices.

It will be appreciated that the above notification and acquisition of user authorization process are only schematic and do not limit the implementations of the present disclosure. Other methods that meet relevant laws and regulations may also be applied to the implementation of the present disclosure.

As discussed, traditional video generation models face challenges in generating long sequences that convey clear and informative events, limiting their ability to support coherent narrations.

According to embodiments of the present disclosure, a token sequence is generated based on an input text using an auto-regressive model, the token sequence comprising a plurality of token groups, each token group comprising an action token and a caption token associated with a video clip, the action token indicating a theme of the video clip. Further, text conditional information and visual conditional information are determined based on the token sequence, the text conditional information comprising a plurality of caption tokens comprised in the token sequence. A plurality of video clips are further generated based at least on the text conditional information and the visual conditional information.

In this way, the embodiments of the present disclosure may enable the generation of videos with sustained narratives. Further, the embodiments of the present disclosure may ensure the consistency of the visual and semantic elements of the video.

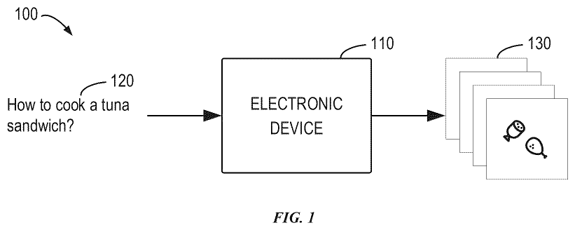

FIG. 1 illustrates a schematic diagram of an example environment 100 in which embodiments of the present disclosure can be implemented. In the example environment 100 of FIG. 1, an electronic device 110 may obtain an input text 120. For example, the input text 120 may comprise “How to cook a tuna sandwich?”.

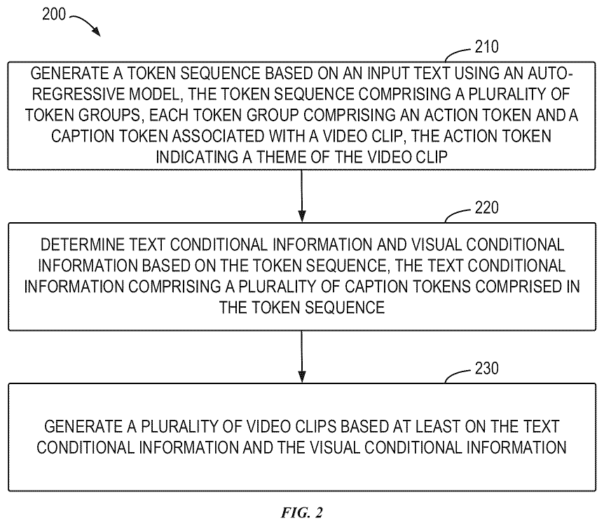

As shown, the electronic device 110 may generate a video 130 based on the input text 120. The video 130 may comprise a plurality of video clips. The video generation method will be discussed in detail with reference to FIG. 2 below.

In some embodiments, the electronic device 110 may be any type of mobile terminal, fixed terminal, or portable terminal, including a mobile phone, a desktop computer, a laptop, a notebook, a netbook, a tablet, a media computer, a multimedia tablet, a personal communication system (PCS) device, a personal navigation device, a personal digital assistant (PDA), an audio/video player, a digital camera/video camera, positioning device, television receiver, radio broadcast receiver, c-book device, gaming device, or any combination of the foregoing, including accessories and peripherals for these devices or any combination thereof. In some embodiments, the electronic device 110 can also support any type of user-specific interface (such as “wearable” circuitry). The electronic device 110 can also be various types of computing systems/servers capable of providing computing capability, including but not limited to, a mainframe, an edge computing node, a computing device in cloud environment, and the like.

It should be understood that the structure and function of each element in the environment 100 is described for illustrative purposes only and does not imply any limitations on the scope of the present disclosure.

Some example embodiments of the present disclosure will continue to be described below with reference to the accompanying drawings.

FIG. 2 illustrates a flow chart of a process 200 for video generation in accordance with some embodiments of the present disclosure. The process 200 can be implemented at the electronic device 110 as shown in FIG. 1.

As shown in FIG. 2, at block 210, the electronic device 110 generates a token sequence based on an input text 120 using an auto-regressive model, the token sequence comprising a plurality of token groups, each token group comprising an action token and a caption token associated with a video clip, the action token indicating a theme of the video clip.

In some embodiments, for generating a narrative video 130 based on the input text 120, a narrative video director may be implemented based on an auto-regressive model.

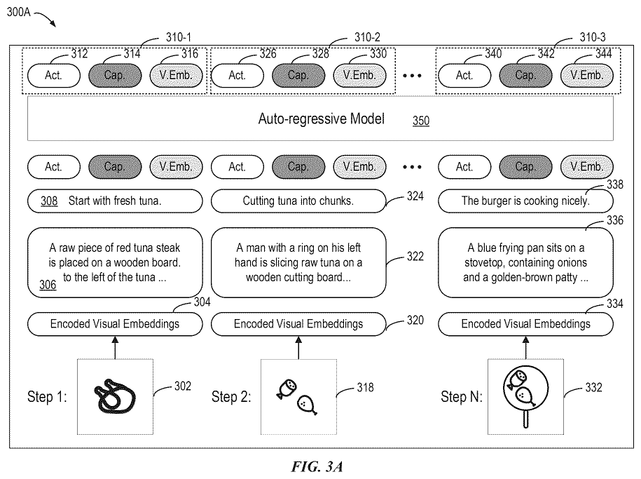

FIG. 3A illustrates an example auto-regressive model in accordance with some embodiments of the present disclosure.

As shown in FIG. 3A, an auto-regressive model 350 may comprise a visual language model. As shown, the auto-regressive model 350 may generate a token sequence where text tokens and visual embeddings are interleaved, integrating narrative and visual content tightly. For example, the text tokens may comprise an action token 312 and a caption token 314, and the visual embedding 316 can be generated based on the action token 312 and the caption token 314.

As shown in FIG. 3A, the token sequence generated by the auto-regressive model 350 may comprise a plurality of token groups. e.g., token group 310-1, token group 310-2, and token group 310-3.

Each token group may comprise both the text tokens and the visual embedding associated with a video clip. For example, the token group 310-1 may correspond to a first video clip to be generated.

During the video generation, the electronic device 110 may provide the input text 120 (e.g., “How to cook a tuna sandwich?”) and an initial image-text pair into the auto-regressive model 350.

The auto-regressive model 350 may then predict the next token based on the accumulated context of both text and images, maintaining narrative coherence and aligning visuals with the text.

For example, the auto-regressive model 350 may generate the action token 312 first. For example, the action token 312 may indicate a theme of the first video clip, e.g., “start with fresh tuna”, e.g., a step to cook a tuna sandwich.

Further, the auto-regressive model 350 may further generate the caption token 314 corresponding to the first video clip. The caption token 314 may describe the image content of the first video clip to be generated. For example, the caption token 314 may comprise “A raw piece of red tuna steak is placed on a wooden board . . . ”.

Further, the auto-regressive model 350 may generate the visual embedding 316 corresponding to the first video clip. In some embodiments, the auto-regressive conditioning is given by equation (1):

$$p ( {y}_{t} \vert {y}_{1 : t - 1} ) = p ( {c}_{t} \vert {c}_{1 : t - 1} ) \cdot p ( {z}_{t} \vert {c}_{1 : t} , {z}_{1 : t - 1} ) \qquad ( 1 )$$

wherein cₜ represents text tokens, and zₜ represents visual embeddings.

Further, as shown in FIG. 3A, the auto-regressive model 350 may generate a coherent narrative sequence by progressively conditioning each step on the cumulative context from previous steps.

For example, at each time step t, the auto-regressive model 350 generates an action token aₜ, a caption token cₜ, and a visual embedding zₜ, conditioned on the cumulative history:

$$\begin{matrix}{ℋ}_{t - 1} = \{ {a}_{1 : t - 1} , {c}_{1 : t - 1} , {z}_{1 : t - 1} \} \\ {a}_{t} \vert {ℋ}_{t - 1} \to {c}_{i} \vert \{ {ℋ}_{t - 1} , {a}_{t} \} \to {z}_{t} \vert \{ {ℋ}_{t - 1} , {a}_{t} , {c}_{t} \}\end{matrix} \qquad ( 2 )$$

For example, during generating the token group 310-2 corresponding to the second video clip, the auto-regressive model 350 may first generate the action token 326 based on the token group 310-1, and then generate the caption token 328 based on both the token group 310-1 and the generated action token 326.

Further, the auto-regressive model 350 may generate the visual embedding 330 based on the token group 310-1, the generated action token 326 and caption token 328.

The token group 310-3 corresponding to a last video clip may be generated by the auto-regressive model 350 in a similar way.

In some embodiments, during training the auto-regressive model 350, the text tokens may be supervised with cross-entropy loss. For example, an entropy loss associated with action may be determined based on the generated action tokens 312, 326 and 340 and the labeled actions 308, 324 and 338.

Further, an entropy loss associated with caption may be determined based on the generated caption tokens 314, 328 and 342 and the labeled actions 306, 322 and 336.

To align the generated visual embeddings z_{pred} (e.g., the visual embeddings 316, 330 and 344) with the target latents z_{target} (e.g., the encoded visual embeddings 304, 320 and 334), a combined loss may be used:

$${L}_{red} = α ( 1 - \frac{{z}_{pred} \cdot {z}_{target}}{‖ {z}_{pred} ‖ ‖ {z}_{target} ‖} ) + β \frac{1}{N} {\sum }_{i = 1}^{N} {( {\hat{z}}_{i} - {z}_{i} )}^{2} \qquad ( 3 )$$

where α and β may balance the contributions of cosine similarity and mean squared error to regress both scale and direction.

In some embodiments, a CLIP (Contrastive Language-Image Pre-training) encoder E_{clip} may encode the frames 320, 318 and 332 of each video clip into the visual embeddings 304, 320 and 334. This may generate language-aligned visual embeddings.

At block 220, the electronic device 110 determines text conditional information and visual conditional information based on the token sequence, the text conditional information comprising a plurality of caption tokens comprised in the token sequence.

Continuing with the example of FIG. 3A, the electronic device 110 may obtain the plurality of caption tokens 314, 328 and 342 comprised in the token sequence as the text conditional information, and may obtain the plurality of visual embeddings 316, 330 and 344 comprised in the token sequence as the visual conditional information.

In some further embodiments, the interleaved auto-regressive model 350 may also act as a language-centric director when reduced to using only text-based guidance. In this case, keyframes are synthesized using a text-conditioned diffusion model with only captions.

In particular, the electronic device 110 may generate a plurality of reference images (e.g., keyframes) based on the caption tokens comprised in the token sequence, and may determine the visual conditional information based on the plurality of reference images.

For example, for each caption token cₜ, a diffusion model Dₜₑₓₜ generates the visual state xₜ=Dₜₑₓₜ(cₜ). This text-only approach benefits from straightforward integration with off-the-shelf text-conditioned diffusion models and hence enjoys high-fidelity image generation.

At block 230, the electronic device 110 generates a plurality of video clips based at least on the text conditional information and the visual conditional information.

As discussed above, the auto-regressive model 350 may generate both text and visual conditions, enabling the video generation process to be conditioned either on keyframes (VAE (Variational Auto Encoder) embeddings) or on CLIP latents regressed by the interleaved director.

As shown in FIG. 3B, the video generation model 360 may generate a plurality of video clips 376 and 378 based at least on the text conditional information (e.g., the caption tokens 372) and the visual conditional information (e.g., the visual embeddings 374). For example, the video clips 376 and 378 may correspond to different steps regarding “How to cook a tuna sandwich”.

In some embodiments, the electronic device 110 may decode the visual conditional information into a plurality of frames using a visual decoder. For example, by using these regressed visual embeddings zₜ directly, each frame 370 is generated as xₜ=Dᵥᵢₛᵤₐₗ(zₜ), ensuring that the video accurately follows the narrative and enhancing consistency by relying on narrative-aligned embeddings rather than potentially biased keyframes.

Alternatively, the video generation model 360 may also typically use the captions 364 and the initial keyframes 366 to guide the model.

In some embodiments, the video generation model 360 for generating the plurality of video clips may be trained through: obtaining a training visual embedding generated by the auto-regressive model; adding a predetermined noise to the training visual embedding to derive a noisy visual embedding; and training the video generation model based on the noisy visual embedding.

For example, to enhance the video generation model's robustness to imperfect visual embeddings zₜ from the auto-regressive director, the video generation model 360 may be fine-tuned using noisy embeddings zₜ′ defined by:

$${z}_{t}^{′} = 𝒮 ( ℳ ( {z}_{t} + ϵ ) ) \qquad ( 4 )$$

Where ϵ˜ [symbol] (0, σ²zₜ) represents Gaussian noise, [symbol] is a masking operator that sets a fraction elements to zero, and S [symbol] is a shuffling operator that permutes some embedding dimensions.

Training with zₜ′ improves the model's ability to handle noisy visual conditions, improving generation quality and robustness with imperfect embeddings.

In this way, the embodiments of the present disclosure may enable the generation of videos with sustained narratives. Further, the embodiments of the present disclosure may ensure the consistency of the visual and semantic elements of the video.

In some embodiments, the auto-regressive model may be trained using any proper training device. The training device may determine training action information corresponding to a plurality of clips of a training video.

For example, the training device may use ASR-based pseudo labels for “actions” in each video, further refined by language model to provide enhanced annotations of the actions throughout the video.

Further, the training device may match training caption information of the training video with the training action information. In particular, the training device may determine an overlap between a first time interval of a caption label and a second time interval of an action label. In response to the overlap satisfying a predetermined condition, the training device may determine that the caption label matches with the action label.

For example, to ensure alignment between captions and actions, Intersection over Union (IoU) may be used as a metric for evaluating whether the overlap between the captioned clip time and action time meets a threshold.

An action is considered a match if the following conditions are met: the difference between the clip start time and the action start time (start diff) is less than 5 seconds; the clip end time is later than the action end time; and the IoU between the clip and action time intervals is greater than 0.25. Also, if IoU>0.5, the action is also considered a match. Here, clip time and action time represent the time intervals for the clip and action, respectively.

In this way, the embodiments may filter and match captions to actions, ensuring that each caption aligns with the relevant action.

Further, the training device may train the auto-regressive model using the matched training action information and training caption information.

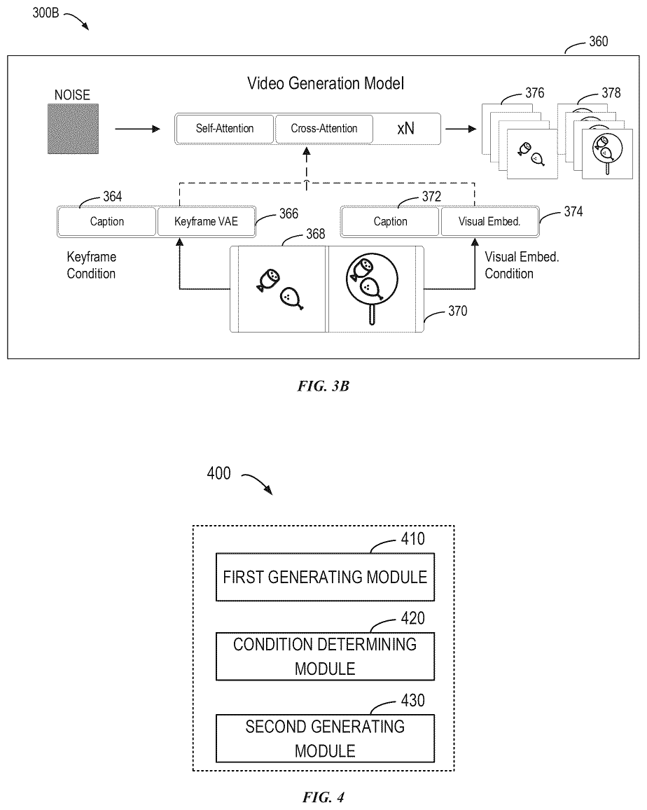

FIG. 4 shows a block diagram of an apparatus 400 for video generation in accordance with some embodiments of the present disclosure. The apparatus 400 may be implemented, for example, or included at the electronic device 110 of FIG. 1. Various modules/components in the apparatus 400 may be implemented by hardware, software, firmware, or any combination thereof.

As shown, the apparatus 400 comprises a first generation module 410 configured to generate a token sequence based on an input text using an auto-regressive model, the token sequence comprising a plurality of token groups, each token group comprising an action token and a caption token associated with a video clip, the action token indicating a theme of the video clip; condition determining module 420 configured to determine text conditional information and visual conditional information based on the token sequence, the text conditional information comprising a plurality of caption tokens comprised in the token sequence; and a second generation module 430 configured to generating a plurality of video clips based at least on the text conditional information and the visual conditional information.

In some embodiments, the visual conditional information comprises a plurality of visual embeddings comprised in the generated token sequence.

In some embodiments, generating a token sequence based on the input text using an auto-regressive model comprises: providing the input text and an initial image-text pair into the auto-regressive model; and obtaining the token sequence generated by the auto-regressive model.

In some embodiments, obtaining the token sequence generated by the auto-regressive model comprises: generating a first token group corresponding to a first video clip based on the input text and the initial image-text pair, the first token group comprising a first action token, a first caption token and a frst visual embedding; generating a second action token and a second caption token based on the first token group; and generating a second visual embedding based on the second action token, the second caption token and the first token group.

In some embodiments, determining the visual conditional information based on the token sequence comprises: generating a plurality of reference images based on the caption tokens comprised in the token sequence; and determining the visual conditional information based on the plurality of reference images.

In some embodiments, generating a plurality of video clips based at least on the text conditional information and the visual conditional information comprises: decoding the visual conditional information into a plurality of frames using a visual decoder; and generating the plurality of video clips based on the plurality of frames and the text conditional information.

In some embodiments, the auto-regressive model is trained through: determining training action information corresponding to a plurality of clips of a training video; matching training caption information of the training video with the training action information; and training the auto-regressive model using the matched training action information and training caption information.

In some embodiments, matching training caption information of the training video with the training action information comprises: determining an overlap between a first time interval of a caption label and a second time interval of an action label; and in response to the overlap satisfying a predetermined condition, determining that the caption label matches with the action label.

In some embodiments, a video generation model for generating the plurality of video clips is trained through: obtaining a training visual embedding generated by the auto-regressive model; adding a predetermined noise to the training visual embedding to derive a noisy visual embedding; and training the video generation model based on the noisy visual embedding.

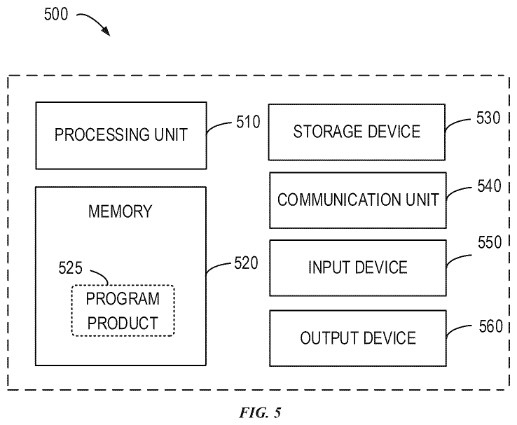

FIG. 5 illustrates a block diagram of an electronic device 500 in which one or more embodiments of the present disclosure can be implemented. It would be appreciated that the electronic device 500 shown in FIG. 5 is only an example and should not constitute any restriction on the function and scope of the embodiments described herein. The electronic device 500 may be used, for example, to implement the electronic device 110 of FIG. 1. The electronic device 500 may also be used to implement the apparatus 400 of FIG. 4.

As shown in FIG. 5, the electronic device 500 is in the form of a general computing device. The components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and can execute various processes according to the programs stored in the memory 520. In a multiprocessor system, multiple processing units execute computer executable instructions in parallel to improve the parallel processing capability of the electronic device 500.

The electronic device 500 typically includes a variety of computer storage medium. Such medium may be any available medium that is accessible to the electronic device 500, including but not limited to volatile and non-volatile medium, removable and non-removable medium. The memory 520 may be volatile memory (for example, a register, cache, a random access memory (RAM)), a non-volatile memory (for example, a read-only memory (ROM), an electrically erasable programmable read-only memory (EEPROM), a flash memory) or any combination thereof. The storage device 530 may be any removable or non-removable medium, and may include a machine-readable medium, such as a flash drive, a disk, or any other medium, which can be used to store information and/or data (such as training data for training) and can be accessed within the electronic device 500.

The electronic device 500 may further include additional removable/non-removable, volatile/non-volatile storage medium. Although not shown in FIG. 5, a disk driver for reading from or writing to a removable, non-volatile disk (such as a “floppy disk”), and an optical disk driver for reading from or writing to a removable, non-volatile optical disk can be provided. In these cases, each driver may be connected to the bus (not shown) by one or more data medium interfaces. The memory 520 may include a computer program product 525, which has one or more program modules configured to perform various methods or acts of various embodiments of the present disclosure.

The communication unit 540 communicates with a further computing device through the communication medium. In addition, functions of components in the electronic device 500 may be implemented by a single computing cluster or multiple computing machines, which can communicate through a communication connection. Therefore, the electronic device 500 may be operated in a networking environment using a logical connection with one or more other servers, a network personal computer (PC), or another network node.

The input device 550 may be one or more input devices, such as a mouse, a keyboard, a trackball, etc. The output device 560 may be one or more output devices, such as a display, a speaker, a printer, etc. The electronic device 500 may also communicate with one or more external devices (not shown) through the communication unit 540 as required. The external device, such as a storage device, a display device, etc., communicate with one or more devices that enable users to interact with the electronic device 500, or communicate with any device (for example, a network card, a modem, etc.) that makes the electronic device 500 communicate with one or more other computing devices. Such communication may be executed via an input/output (I/O) interface (not shown).

According to example implementation of the present disclosure, a computer-readable storage medium is provided, on which a computer-executable instruction or computer program is stored, where the computer-executable instructions or the computer program is executed by the processor to implement the method described above. According to example implementation of the present disclosure, a computer program product is also provided. The computer program product is physically stored on a non-transient computer-readable medium and includes computer-executable instructions, which are executed by the processor to implement the method described above.

Various aspects of the present disclosure are described herein with reference to the flow chart and/or the block diagram of the method, the device, the equipment and the computer program product implemented in accordance with the present disclosure. It would be appreciated that each block of the flowchart and/or the block diagram and the combination of each block in the flowchart and/or the block diagram may be implemented by computer-readable program instructions.

These computer-readable program instructions may be provided to the processing units of general-purpose computers, special computers or other programmable data processing devices to produce a machine that generates a device to implement the functions/acts specified in one or more blocks in the flow chart and/or the block diagram when these instructions are executed through the processing units of the computer or other programmable data processing devices. These computer-readable program instructions may also be stored in a computer-readable storage medium. These instructions enable a computer, a programmable data processing device and/or other devices to work in a specific way. Therefore, the computer-readable medium containing the instructions includes a product, which includes instructions to implement various aspects of the functions/acts specified in one or more blocks in the flowchart and/or the block diagram.

The computer-readable program instructions may be loaded onto a computer, other programmable data processing apparatus, or other devices, so that a series of operational steps can be performed on a computer, other programmable data processing apparatus, or other devices, to generate a computer-implemented process, such that the instructions which execute on a computer, other programmable data processing apparatus, or other devices implement the functions/acts specified in one or more blocks in the flowchart and/or the block diagram.

The flowchart and the block diagram in the drawings show the possible architecture, functions and operations of the system, the method and the computer program product implemented in accordance with the present disclosure. In this regard, each block in the flowchart or the block diagram may represent a part of a module, a program segment or instructions, which contains one or more executable instructions for implementing the specified logic function. In some alternative implementations, the functions marked in the block may also occur in a different order from those marked in the drawings. For example, two consecutive blocks may actually be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by the combination of dedicated hardware and computer instructions.

Each implementation of the present disclosure has been described above. The above description is example, not exhaustive, and is not limited to the disclosed implementations. Without departing from the scope and spirit of the described implementations, many modifications and changes are obvious to ordinary skill in the art. The selection of terms used in this article aims to best explain the principles, practical application or improvement of technology in the market of each implementation, or to enable other ordinary skill in the art to understand the various embodiments disclosed herein.

What is claimed is:

1. A method for video generation, comprising:
generating a token sequence based on an input text using an auto-regressive model, the token sequence comprising a plurality of token groups, each token group comprising an action token and a caption token associated with a video clip, the action token indicating a theme of the video clip;
determining text conditional information and visual conditional information based on the token sequence, the text conditional information comprising a plurality of caption tokens comprised in the token sequence; and
generating a plurality of video clips based at least on the text conditional information and the visual conditional information.

2. The method of claim 1, wherein the visual conditional information comprises a plurality of visual embeddings comprised in the generated token sequence.

3. The method of claim 2, wherein generating a token sequence based on the input text using an auto-regressive model comprises:
providing the input text and an initial image-text pair into the auto-regressive model; and
obtaining the token sequence generated by the auto-regressive model.

4. The method of claim 3, wherein obtaining the token sequence generated by the auto-regressive model comprises:
generating a first token group corresponding to a first video clip based on the input text and the initial image-text pair, the first token group comprising a first action token, a first caption token and a first visual embedding;
generating a second action token and a second caption token based on the first token group; and
generating a second visual embedding based on the second action token, the second caption token and the first token group.

5. The method of claim 1, wherein determining the visual conditional information based on the token sequence comprises:
generating a plurality of reference images based on the caption tokens comprised in the token sequence; and
determining the visual conditional information based on the plurality of reference images.

6. The method of claim 1, wherein generating a plurality of video clips based at least on the text conditional information and the visual conditional information comprises:
decoding the visual conditional information into a plurality of frames using a visual decoder; and
generating the plurality of video clips based on the plurality of frames and the text conditional information.

7. The method of claim 1, wherein the auto-regressive model is trained through:
determining training action information corresponding to a plurality of clips of a training video;
matching training caption information of the training video with the training action information; and
training the auto-regressive model using the matched training action information and training caption information.

8. The method of claim 7, wherein matching training caption information of the training video with the training action information comprises:
determining an overlap between a first time interval of a caption label and a second time interval of an action label; and
in response to the overlap satisfying a predetermined condition, determining that the caption label matches with the action label.

9. The method of claim 1, wherein a video generation model for generating the plurality of video clips is trained through:
obtaining a training visual embedding generated by the auto-regressive model;
adding a predetermined noise to the training visual embedding to derive a noisy visual embedding; and
training the video generation model based on the noisy visual embedding.

10. An electronic device, comprising:
at least one processing unit; and
at least one memory coupled to the at least one processing unit and storing instructions executable by the at least one processing unit, the instructions, upon execution by the at least one processing unit, causing the electronic device to perform actions comprising:
generating a token sequence based on an input text using an auto-regressive model, the token sequence comprising a plurality of token groups, each token group comprising an action token and a caption token associated with a video clip, the action token indicating a theme of the video clip;
determining text conditional information and visual conditional information based on the token sequence, the text conditional information comprising a plurality of caption tokens comprised in the token sequence; and
generating a plurality of video clips based at least on the text conditional information and the visual conditional information.

11. The electronic device of claim 10, wherein the visual conditional information comprises a plurality of visual embeddings comprised in the generated token sequence.

12. The electronic device of claim 11, wherein generating a token sequence based on the input text using an auto-regressive model comprises:
providing the input text and an initial image-text pair into the auto-regressive model; and
obtaining the token sequence generated by the auto-regressive model.

13. The electronic device of claim 12, wherein obtaining the token sequence generated by the auto-regressive model comprises:
generating a first token group corresponding to a first video clip based on the input text and the initial image-text pair, the first token group comprising a first action token, a first caption token and a first visual embedding;
generating a second action token and a second caption token based on the first token group; and
generating a second visual embedding based on the second action token, the second caption token and the first token group.

14. The electronic device of claim 10, wherein determining the visual conditional information based on the token sequence comprises:
generating a plurality of reference images based on the caption tokens comprised in the token sequence; and
determining the visual conditional information based on the plurality of reference images.

15. The electronic device of claim 10, wherein generating a plurality of video clips based at least on the text conditional information and the visual conditional information comprises:
decoding the visual conditional information into a plurality of frames using a visual decoder; and
generating the plurality of video clips based on the plurality of frames and the text conditional information.

16. The electronic device of claim 10, wherein the auto-regressive model is trained through:
determining training action information corresponding to a plurality of clips of a training video;
matching training caption information of the training video with the training action information; and
training the auto-regressive model using the matched training action information and training caption information.

17. The electronic device of claim 16, wherein matching training caption information of the training video with the training action information comprises:
determining an overlap between a first time interval of a caption label and a second time interval of an action label; and
in response to the overlap satisfying a predetermined condition, determining that the caption label matches with the action label.

18. The electronic device of claim 10, wherein a video generation model for generating the plurality of video clips is trained through:
obtaining a training visual embedding generated by the auto-regressive model;
adding a predetermined noise to the training visual embedding to derive a noisy visual embedding; and
training the video generation model based on the noisy visual embedding.

19. A non-transitory computer-readable storage medium, having a computer program stored thereon which, upon execution by an electronic device, causes the device to perform actions comprising:
generating a token sequence based on an input text using an auto-regressive model, the token sequence comprising a plurality of token groups, each token group comprising an action token and a caption token associated with a video clip, the action token indicating a theme of the video clip;
determining text conditional information and visual conditional information based on the token sequence, the text conditional information comprising a plurality of caption tokens comprised in the token sequence; and
generating a plurality of video clips based at least on the text conditional information and the visual conditional information.

20. The non-transitory computer-readable storage medium of claim 19, wherein the visual conditional information comprises a plurality of visual embeddings comprised in the generated token sequence.
